(19) United States
(12) Patent Application Publication
(10) Pub. No.: US 2013/0340176 A1
(43) Pub. Date: Dec. 26, 2013

(54) MANAGING MATTRESS PRESSURE ON WOUNDS

(71) Applicant: INTERNATIONAL BUSINESS MACHINES CORPORATION, (US)

(72) Inventors: Mark B. Stevens, Austin, TX (US); John D. Wilson, Houston, TX (US)

(73) Assignee: INTERNATIONAL BUSINESS MACHINES CORPORATION, Armonk, NY (US)

(21) Appl. No.: 13/778,065

(22) Filed: Feb. 26, 2013

Related U.S. Application Data
(63) Continuation of application No. 13/527,816, filed on Jun. 20, 2012.

(51) Int. Cl. A61G 7/057

(52) U.S. Cl. CPC A61G 7/057
USPC 5/710; 5/690

(57) ABSTRACT

A method for adjusting a mattress to minimize pressure on a patient wound including detecting a location of the patient wound relative to the mattress, and responsive to detecting the location of the patient wound relative to the mattress, adjusting the mattress to minimize pressure on the patient wound.

This application is a continuation of application Ser. No. 13/527,816 filed Jun. 20, 2012 entitled “MANAGING MATTRESS PRESSURE ON WOUNDS”, the disclosure of which is incorporated in its entirety herein by reference.

### BACKGROUND

1. Technical Field

The present invention relates generally to managing pressure on wounds, and in particular, to a computer implemented method for managing mattress pressure on wounds with an active mattress.

2. Description of Related Art

Bedsores are a medical problem for persons that are bedridden or otherwise restricted in movement. Bedsores are skin lesions or wounds that occur when body parts rub, shear, or are held with body weight pressure for extended periods of time against surfaces such as mattresses, bed sheets, wheel chairs, etc. Typically bedsores occur where soft tissue underlies bony prominences such as heels, tailbones, hips, and craniums. Bedsores are painful and prone to infections which can spread to the bones and bloodstream.

There are four stages of bedsores or lesions with stage I being the mildest and stage IV being the worst. A stage I lesion is the most superficial, indicated by redness of a localized area. A stage II lesion has damage extending into but not deeper than the skin. A stage III lesion extends through the skin and may extend into the soft tissues under the skin. Stage IV lesions are the deepest, extending into muscle, tendon, or even bone.

Bedsores are generally caused by one or more of three different forces. The first is pressure or compression of tissues, generally under a bony protuberance, causing reduced blood flow to an area. The second is friction or rubbing of skin against another surface such as hospital bed sheets. The third is shear force where the skin may stay in place against a sheet, but the underlying soft and hard tissues move thereby pinching blood vessels.

Various techniques exist for reducing the likelihood of bedsores. For example, patients may be repositioned every two hours to avoid prolonged periods of pressure on any given area. Also various types of beds have been developed such as water beds and sand beds, generally to equalize pressure across the body of the patient.

Once started, bedsores are very difficult and expensive to treat, often requiring hospitalization. In addition, those affected by bedsores are often the persons who can least afford to deal with additional medical issues such as the elderly, stroke victims, diabetics, etc. They are typically the least mobile and the most susceptible as a result.

### SUMMARY

The illustrative embodiments provide a method for adjusting a mattress to minimize pressure on a patient wound including detecting a location of the patient wound relative to the mattress, and responsive to detecting the location of the patient wound relative to the mattress, adjusting the mattress to minimize pressure on the patient wound.

### BRIEF DESCRIPTION OF THE SEVERAL VIEWS OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 is a block diagram of a data processing system in which various embodiments may be implemented;

FIG. 2 is a block diagram of a network of data processing systems in which various embodiments may be implemented;

FIG. 3 is a top view of a mattress in which various embodiments may be implemented;

FIGS. 4A and 4B are cutaway views of the mattress showing the individuals cells that may be pressurized or depressurized in which various embodiments may be implemented;

FIG. 5 is a side cutaway view of an individual mattress cell in which various embodiments may be implemented;

FIG. 6 is a block diagram of a mattress system in which various embodiments may be implemented;

FIGS. 7A and 7B are top views of wound markers in accordance with a first and a second embodiment;

FIG. 8 is a flow diagram of the operation of the control system for the active mattress in accordance with a first embodiment; and

FIG. 9 is a flow diagram of the operation of the control system for the active mattress in accordance with a second embodiment.

### DETAILED DESCRIPTION

Steps may be taken to manage pressure on lesions with an active mattress. These steps may be taken as will be explained with reference to the various embodiments below.

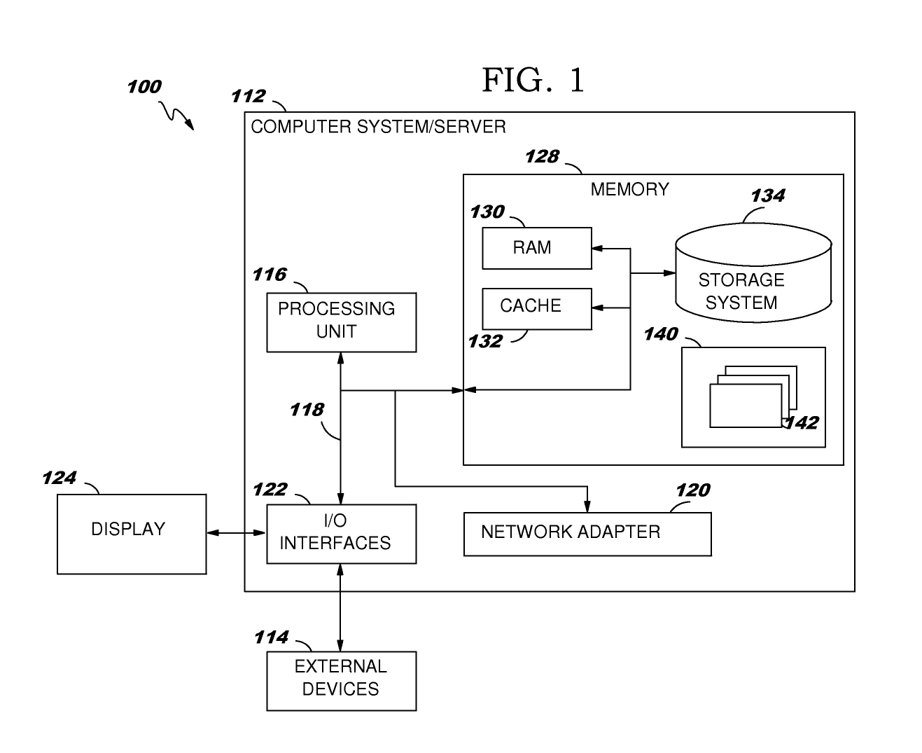

FIG. 1 is a block diagram of a data processing system in which various embodiments may be implemented. Data processing system 100 is only one example of a suitable data processing system and is not intended to suggest any limitation as to the scope of use or functionality of embodiments of the invention described herein. Regardless, data processing system 100 is capable of being implemented and/or performing any of the functionality set forth herein.

In data processing system 100 there is a computer system/server 112, which is operational with numerous other general purpose or special purpose computing system environments or configurations. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 112 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 112 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 112 in data processing system 100 is shown in the form of a general-purpose computing device. The components of computer system/server 112 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of computer system readable media. Such media may be any available media that is accessible by computer system/server 112, and it includes both volatile and non-volatile media, removable and non-removable media.

System memory 128 can include computer system readable media in the form of volatile memory, such as random access memory (RAM) 130 and/or cache memory 132. Computer system/server 112 may further include other removable/non-removable, volatile/non-volatile computer system storage media. By way of example only, storage system 134 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 118 by one or more data media interfaces. Memory 128 may include at least one program product having a set (e.g., at least one) of program modules that are configured to carry out the functions of embodiments of the invention. Memory 128 may also include data that will be processed by a program product.

Program/utility 140, having a set (at least one) of program modules 142, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 142 generally carry out the functions and/or methodologies of embodiments of the invention. For example, a program module may be software for managing mattress pressure on lesions with an active mattress.

Computer system/server 112 may also communicate with one or more external devices 114 such as a keyboard, a pointing device, a display 124, etc.; one or more devices that enable a user to interact with computer system/server 112; and/or any devices (e.g., network card, modem, etc.) that enable computer system/server 112 to communicate with one or more other computing devices. Such communication can occur via I/O interfaces 122. Still yet, computer system/server 112 can communicate with one or more networks such as a local area network (LAN), a general wide area network (WAN), and/or a public network (e.g., the Internet) via network adapter 120. As depicted, network adapter 120 communicates with the other components of computer system/server 112 via bus 118. It should be understood that although not shown, other hardware and/or software components could be used in conjunction with computer system/server 112. Examples, include, but are not limited to: microcode, device drivers, redundant processing units, external disk drive arrays, RAID systems, tape drives, and data archival storage systems, etc.

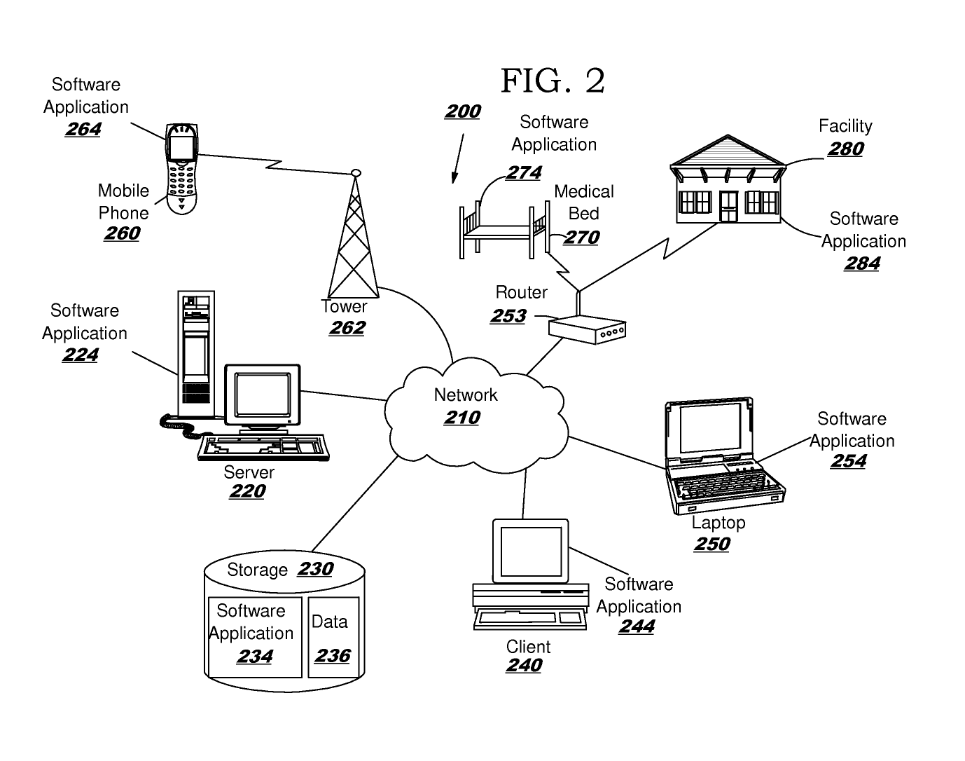

FIG. 2 is a block diagram of a network of data processing systems in which various embodiments may be implemented. Data processing environment 200 is a network of data processing systems such as described above with reference to FIG. 1. Software applications may execute on any computer or other type of data processing system in data processing environment 200. Data processing environment 200 includes network 210. Network 210 is the medium used to provide communications links between various devices and computers connected together within data processing environment 200. Network 210 may include connections such as wire, wireless communication links, or fiber optic cables.

Server 220 and client 240 are coupled to network 210 along with storage unit 230. In addition, laptop 250, medical bed 270, and facility 280 (such as a hospital, business or home) are coupled to network 210 including wirelessly such as through a network router 253. A mobile phone 260 may be coupled to network 210 through a mobile phone tower 262. Data processing systems, such as server 220, client 240, laptop 250, mobile phone 260, hospital bed 270 and facility 280 contain data and have software applications including software tools executing thereon. Other types of data processing systems such as personal digital assistants (PDAs), smartphones, tablets and netbooks may be coupled to network 210.

Server 220 may include software application 224 such as for managing mattress pressure on lesions with an active mattress or other software applications in accordance with embodiments described herein. Storage 230 may contain software application 234 and a content source such as data 236 for storing information regarding the size and location of a lesion. Other software and content may be stored on storage 230 for sharing among various computer or other data processing devices. Client 240 may include software application 244. Laptop 250 and mobile phone 260 may also include software applications 254 and 264. Hospital bed 270 and facility 280 may include software applications 274 and 284. Other types of data processing systems coupled to network 210 may also include software applications. Software applications could include a web browser, email, or other software application that can manage mattress pressure on lesions with an active mattress.

Server 220, storage unit 230, client 240, laptop 250, mobile phone 260, hospital bed 270, and facility 280 and other data processing devices may couple to network 210 using wired connections, wireless communication protocols, or other suitable data connectivity. Client 240 may be, for example, a personal computer or a network computer.

In the depicted example, server 220 may provide data, such as boot files, operating system images, and applications to client 240 and laptop 250. Client 240 and laptop 250 may be clients to server 220 in this example. Client 240, laptop 250, mobile phone 260, hospital bed 270 and facility 280 or some combination thereof, may include their own data, boot files, operating system images, and applications. Data processing environment 200 may include additional servers, clients, and other devices that are not shown.

In the depicted example, data processing environment 200 may be the Internet. Network 210 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 2 is intended as an example, and not as an architectural limitation for the different illustrative embodiments.

Among other uses, data processing environment 200 may be used for implementing a client server environment in which the embodiments may be implemented. A client server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

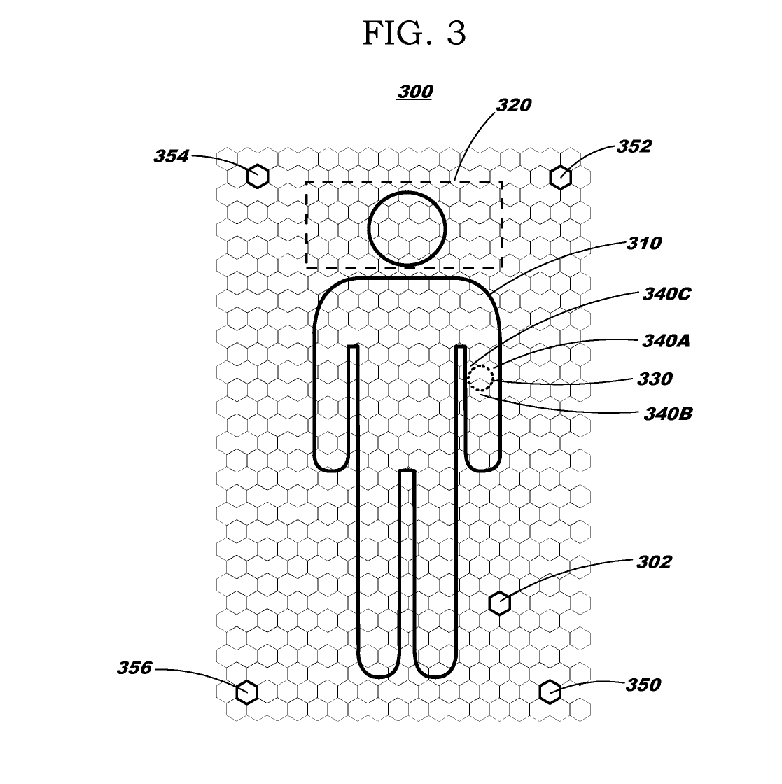

FIG. 3 is a top view of an active mattress in which various embodiments may be implemented. Mattress 300 is composed of multiple cells 302 that can be individually pressurized or depressurized. In the mattress shown, the cells are composed of a honeycomb of hexagonal cells about 2 inches in diameter. Alternative embodiments may use larger cells to reduce cost or smaller cells to provide greater selectivity of support. Alternative embodiments may also use alternative configurations such as square cells or other types of interlocking shapes. Another alternative embodiment could be a pad similarly composed of cells that can be actively and individually pressurized and depressurized. This alternative pad could be placed on top of a regular mattress without such capabilities. A further alternative embodiment may be a mattress similarly composed of cells that may be filled or emptied of a liquid such as a saline solution, thereby providing additional support or relief from pressure for a person by each cell. Such alternative embodiments will also be collectively referred to herein as a mattress.

An outline of a person 310 laying on his or her back and a pillow 320 are shown. The person may have a wound (bedsore, skin lesion or other type of wound) at the back of the elbow against the mattress which may be indicated by a wound marker 330. The wound marker may have various types of indicators that can be detected to indicate the location of the wound relative to the surface of the mattress. These indicators may include magnetic indicators, color indicators, fluorescent indicators, near field indicators (e.g. RFID or radio frequency identification tags), or other indicators to indicate the location of a wound or bedsore relative to the mattress. Other types of methods may be used to detect a wound location without wound markers including heat and color sensors, body position analysis of live video, etc. The location of the wound and/or wound marker relative to the surface of the mattress may be detected as described below. Due to the location of the wound above mattress cells 340A, 340B and 340C, those cells are depressurized to relieve stress against the wound or bedsore. In addition, adjacent cells may also be partially depressurized to provide additional relief. In some circumstances, cells 350, 352, 354 and 356 or other cells may also contain indicators similar to the indicators in the wound marker. The indicators in these cells may be used to help determine the relative location of the wound to the mattress surface, thereby helping locate which mattress cells are closest to the wound marker.

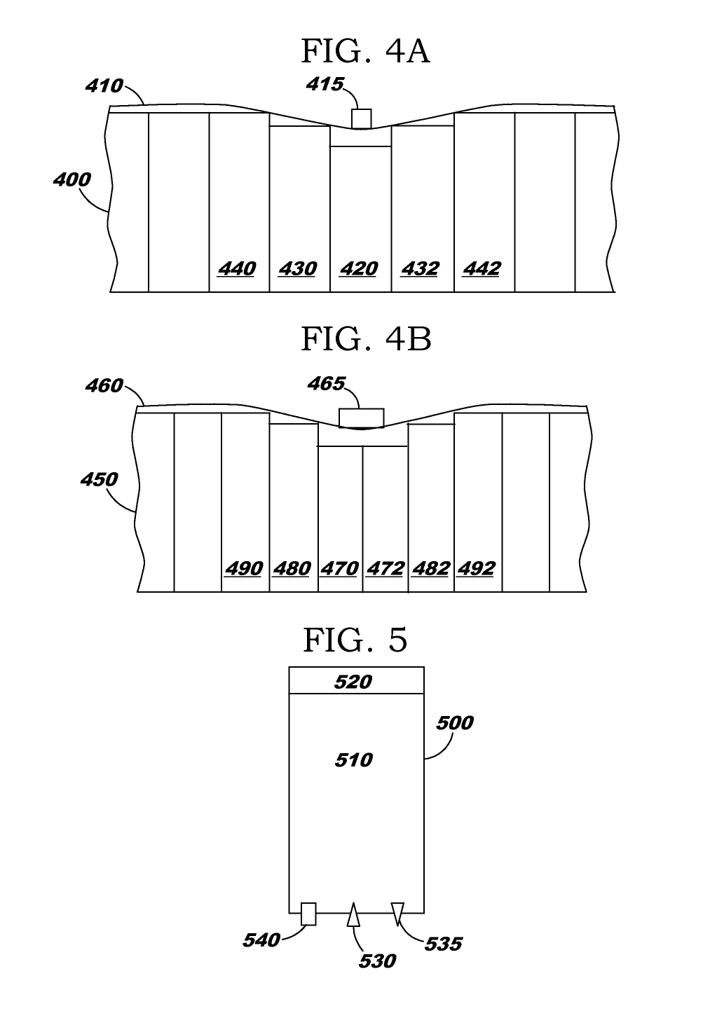

FIGS. 4A and 4B are cutaway views of the mattress showing the individuals cells that may be pressurized or depressurized in which various embodiments may be implemented. In FIG. 4A, mattress 400 is used to support a person 410 with a wound or wound marker 415. In this example, wound 415 is over a single cell 420. In that case, cell 420 may be depressurized significantly and adjacent cells 430 and 432 may also be depressurized somewhat, thereby relieving pressure on the indicated wound area. Other cells 440 and 442 may be increased in pressure to support the surrounding tissue areas of the person and to relieve pressure on the wound area. Alternative pressure changes and configurations may be utilized to relieve pressure on a wound area while supporting the surrounding tissue areas of the person. Although cells 420, 430 and 432 are shown as having a fully horizontal surface area for illustrative purposes, in practice the edges will slope up to the adjacent cell due to the interconnectivity of the edge of each cell with its adjacent cells by cloth or other similar materials.

In FIG. 4B, mattress 450 is used to support a person 460 with a wound or wound marker 465. In this example, wound 465 is over two cells 470 and 472. In that case, cells 470 and 472 may be depressurized significantly and adjacent cells 480 and 482 may also be depressurized somewhat, thereby relieving pressure on the indicated wound area. Other cells 490 and 492 may be increased in pressure to support the surrounding tissue areas of the person and to relieve pressure on the wound area. Alternative pressure changes and configurations may be utilized to relieve pressure on a wound area while supporting the surrounding tissue areas of the person. Although cells 470, 472, 480 and 482 are shown as having a fully horizontal surface area for illustrative purposes, in practice the edges will slope up to the adjacent cell due to the interconnectivity of the edge of each cell with its adjacent cells by cloth or other similar materials.

FIG. 5 is a side cutaway view of an individual mattress cell in which various embodiments may be implemented. Cell 500 has an interior 510 which may be pressurized by air. This air may be room temperature or it may be chilled or heated depending on the needs of the person lying on the mattress. The pressure may also be pulsated for selected cells such as those near a wound area for treatment or the wound or in across all cells in general in order to provide a massaging effect for the person if needed. A sensor 520 may be located on the top of the cell to detect an adjacent wound or wound marker. If detected, a signal may be sent to a control system as described below. Alternatively, sensor 520 may be a pressure sensor to detect the pressure exerted by that cell against the skin of the person. This information may be useful in managing the operation of the mattress. Alternative embodiments may use external sensors to the mattress to detect the location of a wound marker to the mattress, thereby avoiding the need for a sensor at the top of cells. External sensors may include magnetic sensors for detecting magnetic indicators, fluorescent and color sensors for detecting fluorescent and color indicators, video camera(s) such as for detecting the location of a wound area based on the position of the persons' body on the mattress, etc. Cell 500 also includes an air valve 530 for adding pressure to the cell. Air valve may be connected to a pressurized line (not shown). Cell 500 also includes an air valve 535 for releasing pressure from the cell. The air may be released to the open atmosphere or it may be released to a separate line (not shown). Air valves 530 and 535 may be combined as a single air valve able to pressurize and depressurize the cell. Cell 500 further includes a pressure sensor 540 for detecting the amount of pressure in the cell. Sensor 520, air valve 530, air valve 535, and pressure sensor 540 are coupled to a control system for receiving and sending signals controlling the operation of cell 500.

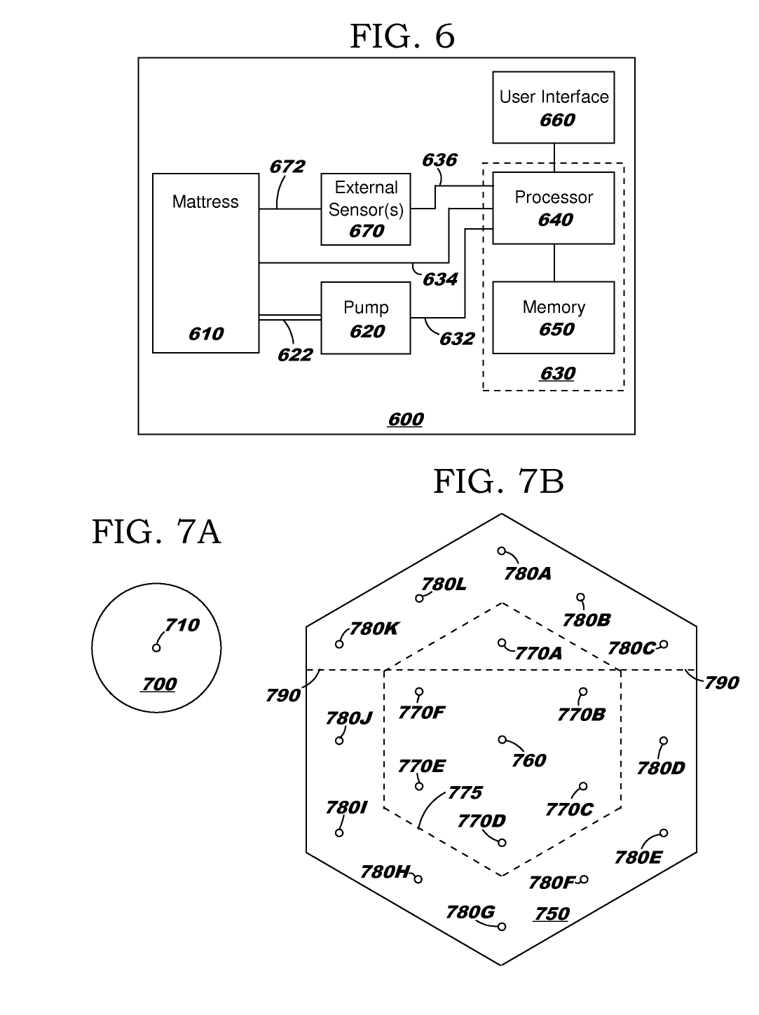

FIG. 6 is a block diagram of a mattress system in which various embodiments may be implemented. Mattress system 600 includes a mattress 610 such as described above with reference to FIGS. 3, 4A, 4B and 5. The individual cells of mattress may be pressurized by pump 620 through pressure line 622. The operation of mattress 610 and pump 620 may be controlled by control system 630 across communication lines 632 and 634. Control system 630 may be integrated with mattress 610 or it may be remote and connected with mattress 610 such as through a local network or through the internet. Communication lines 632 and 634 may be electrical lines, optical lines, wireless connections, or other means of communication. Control system 630 includes a processor 640 for managing the operation of mattress system 600 utilizing programs and data stored in memory 650. Control system 630 may communicate with a medical personnel or other person though a user interface 660 such as a keypad and display. Alternative embodiments may communicate wirelessly with a user through a remote device such as a mobile phone with Bluetooth capabilities. Through communication line 634, processor 640 may control the pressure of each mattress cell by receiving signals from each mattress cell pressure sensor and sending signals to each mattress cell air valve with instructions to open or close as needed, thereby increasing or decreasing mattress cell pressure.

Control system 630 may also be coupled to external sensor(s) 670 across communication line 636. External sensor(s) 670 may be coupled to the mattress through communication line 672. Communication lines 636 and 672 may be electrical lines, optical lines, wireless connections, or other means of communication. External sensor(s) 670 may include magnetic sensors for detecting magnetic indicators, fluorescent and color sensors for detecting fluorescent and color indicators, video camera(s) such as for detecting the location of a wound area based on the position of the persons' body on the mattress, a radio frequency or other near field detector or other type of detector for identifying the location of a wound marker indicator, etc. Additional indicators may be located in selected areas within mattress 610 to allow the control system to determine which mattress cells may be in contact with the wound marker. Alternative types of external sensors may be utilized by mattress system 600 to locate wound marker relative to mattress cells.

FIGS. 7A and 7B are top views of wound markers in accordance with a first and a second embodiment. These wound markers perform several functions. They are used to help cover a wound to help prevent chaffing, to hold any antibiotics or other medicines to the wound, and to absorb any wound oozing or bodily fluids. They are also utilized to identify the location and shape of a wound to the mattress control system. They may be made of a variety of materials including gauze, cotton, and an exterior breathable elastic coating. Wound markers may also have adhesive around the perimeter to adhere the wound marker to the patient.

The wound marker of FIG. 7A may be utilized for wounds that are generally round in shape. Wound marker 700 is round and includes a single indicator 710. If reed switches are being utilized to detect the location of wound indicators, then indicator 710 may be a flexible material such as latex cloth that includes magnetic powder. If a radio frequency or other near field detector is being utilized to detect the location of wound indicators, then indicator 710 may be a flexible RFID or other type of indicator embedded within the wound marker. Alternative systems using other types of detectors may use alternative types of indicators such as LC circuits with a coil at the top of each mattress cell. The presence of a wound marker near a particular cell would change the coil inductance and the oscillation frequency of the LC circuit for that cell, thereby indicating the presence of the wound marker near that cell.

When wound marker 700 is attached to the patient, marker 710 is placed near the center of the wound area. If in a hospital or home care setting, medical personnel or other user may provide the radius or diameter of the wound area to the control system such as through a user interface. Once the mattress control system determines the location of marker 710 relative the mattress cells, then the provided radius of the wound may be utilized to determine which mattress cells are in contact with the wound area. Once determined, then the mattress control system can depressurize the mattress cells in contact with the wound area as well as partially depressurize surrounding mattress cells as needed.

The wound marker of FIG. 7B may be utilized for wounds that are irregular in shape. Wound marker 750 is hexagonal and includes multiple markers 760, 770A through 770F, and 780A through 780L. A smaller wound marker may be as shown by dotted line 775 with markers 760 and 770A through 770F. If reed switches are being utilized to detect the location of wound markers, then the markers may be a flexible material such as latex cloth that includes magnetic powder. If a radio frequency or other type of near field detector is being utilized to detect the location of wound markers, then each marker may be a flexible indicator embedded within the wound marker. Alternative systems using other types of detectors may use alternative types of markers such as LC circuits with a coil at the top of each mattress cell. The presence of a wound marker near a particular cell would change the coil inductance and the oscillation frequency of the LC circuit for that cell, thereby indicating the presence of the wound marker near that cell.

Before attaching wound marker 750 to a patient, the marker may be trimmed to the shape of a wound area using scissors or other cutting instrument. For example, markers 780K, 780L, 780A, 780B, 780C, and 770 may be cut away as shown by dotted line 790. The remaining wound marker with markers 760, 770B through 770F, and 780 D through 780J is them attached to and covering the wound area. Once attached, the mattress control system may determine the location of these markers relative to the mattress to determine which mattress cells may be in contact with the indicated wound area. The location of the markers may be determined by the use of internal or external sensors. Once determined, then the mattress control system can depressurize the mattress cells in contact with the wound area as well as partially depressurize surrounding mattress cells as needed.

Alternative wound markers may be in a variety of configurations. For example, the markers may be in a coordinate grid instead of a hexagonal configuration. In addition, marker 710 may be a magnetic strip in the shape of a large donut. Additional embodiments may utilize a detectable metallic or magnetic ink which can be painted onto a bandage over a wound area to indicate the location of the wound.

Wound markers are not limited to use with bandages. A wound marker may be a magnetic, fluorescent, color or other liquid that could be painted onto the wound area and then dries. For example, a magnetic ink may be painted onto the wound area and then sensed by sensors in each mattress cell. For another example, a bright orange type of liquid or ink could be painted onto the wound area, which could be identified by a video camera. Given that when a wound is against the mattress, it may not be visible from a video camera positioned above the patient, the orange liquid may actually be painted on the opposite side of the body away from the wound.

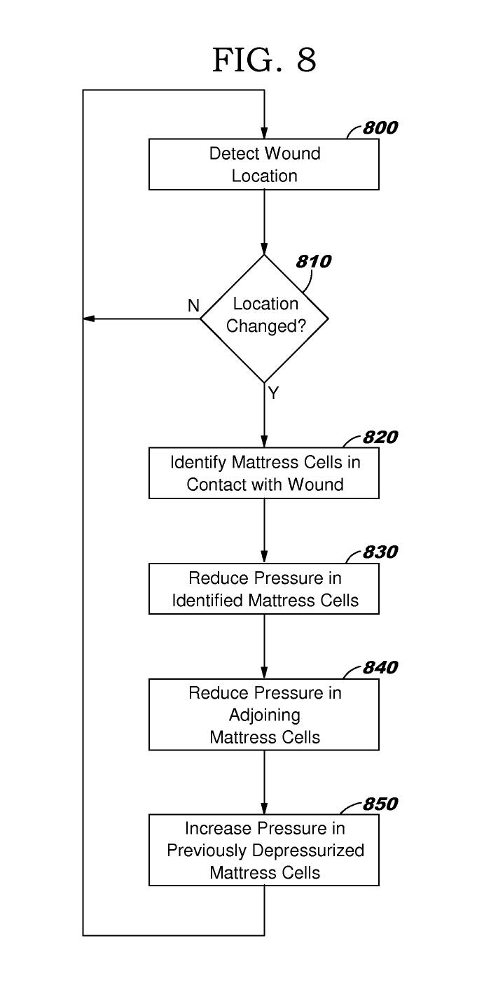

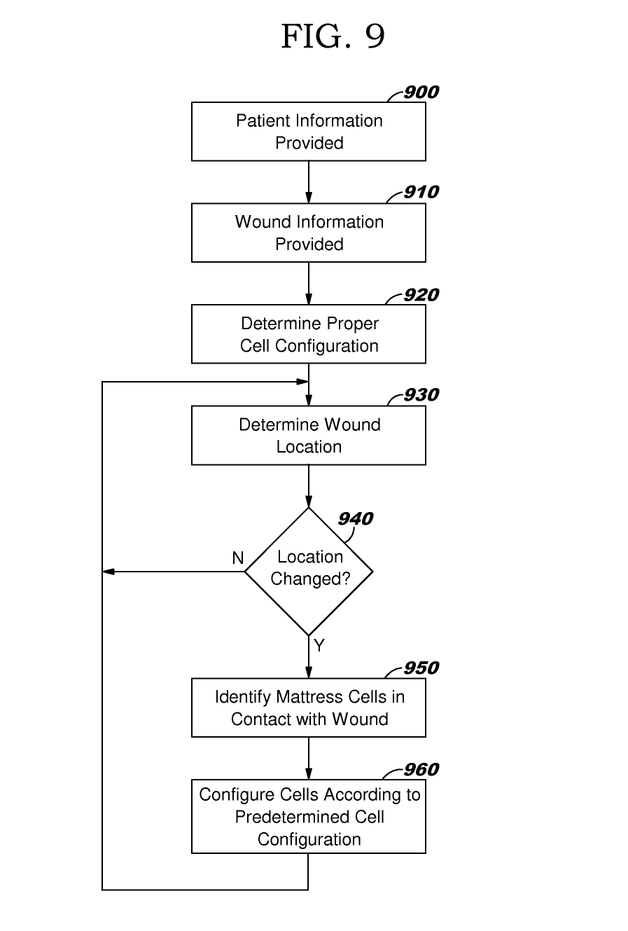

FIG. 8 is a flow diagram of the operation of the control system for the active mattress in accordance with a first embodiment. In a first step 800 the location of the wound or wound marker(s) is determined by detecting the indicator(s) or by other techniques such as described below with reference to FIG. 9. This location may be determined by sensors within each mattress cell or by sensors external to the mattress. Subsequently in step 810, it is determined by the control system whether the location of the wound (such as indicated by a wound marker) has changed. When the person first lies down on the mattress there would not be a previously location to compare to, so that would be deemed a new location. If not, then processing returns to step 800. If the location has changed, then the control system determines which mattress cells are in contact with the wound in step 820. If the wound location is determined by mattress cell sensors, then the location would be over those mattress cell sensors with the strongest signal. If external sensors are utilized, then the location of the wound would be compared to the known location of the mattress cells. This can include determining that the wound is not in contact with any mattress cell such as if the person has rolled over and the wound is now several inches above the mattress. Some mattress cells may also have indicators to assist in this process.

Subsequently, in step 830, the pressure would be reduced significantly in the mattress cells identified as being in contact with the wound. In addition, in step 840, the pressure in the adjoining mattress cells would also be reduced. Furthermore, in step 850, the pressure would be increased in those mattress cells, of those adjoining, that are no longer in contact with the wound. Processing would then return to step 800.

FIG. 9 is a flow diagram of the operation of the control system for the active mattress in accordance with a second embodiment. In a first step 900 the person or a health care provider may enter certain patient information into the mattress control system such as through a user interface such as a touch sensitive display. This information can include a variety of information which may be useful in configuring the mattress cells. Such information can include the size, weight, and age of the person, any relevant personal diagnosis such as diabetes, the mobility of the person, etc. For example, an older person will have skin that is less flexible and more prone to shearing forces. As a result, the relative difference in pressure between mattress cells may be configured to be less than with a younger person.

Subsequently in step 910, information about the wound(s) is provided. For example, the person may have a single Type IV wound than needs minimal pressure regardless of shearing force sensitively with surrounding tissues. The information about the wound may also include information about whether a wound marker is used and the type of wound marker. The information may also include information about the wound location such as when a wound marker is not used. For example, one or more video cameras may be viewing the patient. Through a user interface, a health care provider or other user may indicate the location and size of the patient wound as well as the perimeter of the mattress for tracking purposes. Thereafter, computer analysis of the video can be used to determine the location of the wound relative to the mattress based on the position of the patient. For another example, the wound may be identifiable by certain characteristics such as skin temperature differences in the area of the wound. Such information may be used by thermal sensors or other types of sensors to identify the wound location.

After receiving information about the patient and the wound(s), the mattress control system may then determine the proper cell configuration in step 920. This may be performed by reviewing data from a locally stored database. This may also be performed by contacting a remotely stored server database across a network and/or the internet. A cell configuration may be determined to include pressure values of cells under and surrounding a wound. The cell configuration could also include additional information such as whether certain cells should be pulsed in pressure, whether certain cells should be warmed or cooled, or other alternative configurations to treat the patient and the wound.

Subsequently in step 930 the location of the wound or wound marker(s) is determined by detecting the indicator(s). This location may be determined by sensors within each mattress cell or by sensors external to the mattress. Subsequently in step 940, it is determined by the control system whether the location of the wound has changed, possibly by determining the location of the wound marker when one is utilized. When the person first lies down on the mattress there would not be a previously location to compare to, so that would be deemed a new location. If not, then processing returns to step 930. If the location has changed, then the control system determines which mattress cells are in contact with the wound in step 950. If the wound location is determined by mattress cell sensors, then the location would be over those mattress cell sensors with the strongest signal. If external sensors are utilized, then the location of the wound would be compared to the known location of the mattress cells. This can include determining that the wound is not in contact with any mattress cell such as if the person has rolled over and the wound is now several inches above the mattress. Some mattress cells may also have indicators to assist in this process.

Subsequently, in step 960, the mattress cells are configured relative to the wound location as previously determined in steps 900 through 920 above. This may include decreasing and increasing the pressure of certain mattress cells. This may also include pulsing, heating, cooling or other configuration as may be predetermined. After step 960, processing returns to step 930.

The invention can take the form of an entirely software embodiment, or an embodiment containing both hardware and software elements. In a preferred embodiment, the invention is implemented in software or program code, which includes but is not limited to firmware, resident software, and microcode.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), or Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code such as a software application that can manage mattress pressure on lesions with an active mattress. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method of adjusting a mattress to minimize pressure on a patient wound comprising:
detecting a location of the patient wound relative to the mattress having a first pressure; and
responsive to detecting the location of the patient wound relative to the mattress, adjusting pressure of the mattress to minimize pressure on the patient wound including decreasing mattress pressure near the wound less than the first pressure and increasing mattress pressure surrounding the wound greater than the first pressure.

2. The method of claim 1 wherein detecting a location of the patient wound includes detecting a marker placed on the patient wound and wherein the mattress contains sensors that determine the position of the marker relative to the mattress.

3. The method of claim 1 wherein the mattress includes multiple individually pressurized fluid cells, the pressurized fluid cells selected from a group consisting of pressurized air cells and pressurized liquid cells.

4. The method of claim 3 wherein the mattress includes a control system and wherein adjusting pressure of the mattress includes the control system decreasing cell pressure under the patient wound to reduce pressure on the patient wound and increasing cell pressure radially away and near the patient wound to provide support.

5. The method of claim 4 wherein detecting a location of the patient wound includes detecting a marker placed on the patient wound and wherein the mattress contains sensors that determine the position of the marker relative to the mattress.

6. The method of claim 5 wherein each mattress cell includes a sensor for locating whether the marker is proximate to the sensor.

7. The method of claim 5 wherein the mattress includes external sensors for locating the marker relative to reference indicators located in the mattress.

8. The method of claim 4 wherein information regarding the patient wound is provided to the control system and wherein the control system uses the patient wound information in adjusting the mattress cells.

9-24. (canceled)

25. The method of claim 7 wherein information regarding the patient wound is provided to the control system and wherein the control system uses the patient wound information in adjusting the mattress cells.

26. The method of claim 1 wherein detecting a location of the patient wound includes utilizing an external video camera to detect the location of the patient wound.

27. The method of claim 26 wherein the external video camera utilizes reference indicators located in the mattress to detect the location of the patient wound relative to the reference indicators.

28. The method of claim 26 wherein the external video camera detects heat.

29. The method of claim 4 wherein detecting a location of the patient wound includes utilizing an external video camera to detect the location of the patient wound.

30. The method of claim 29 wherein the external video camera utilizes reference indicators located in the mattress to detect the location of the patient wound relative to the reference indicators.

31. The method of claim 29 wherein the external video camera detects heat.

32. The method of claim 7 wherein detecting a location of the patient wound includes utilizing an external video camera to detect the location of the patient wound.

33. The method of claim 32 wherein the external video camera utilizes reference indicators located in the mattress to detect the location of the patient wound relative to the reference indicators.

34. The method of claim 32 wherein the external video camera detects heat.
